(19) United States
(12) Patent Application Publication
(10) Pub. No.: US 2012/0179560 A1
(43) Pub. Date: Jul. 12, 2012

(54) SYSTEM FOR A SELF-SERVICE PRODUCT DETECTION STATION AND METHOD FOR SAID SYSTEM

(75) Inventors: Gordon Klein, Dallgow (DE); Bernd Kruse, Altenbeken (DE)

(73) Assignee: WINCOR NIXDORF INTERNATIONAL GMBH, Paderborn (DE)

(21) Appl. No.: 13/496,686

(22) PCT Filed: Sep. 21, 2010
(86) PCT No.: PCT/EP2010/005759

§ 371 Date: Mar. 16, 2012

(30) Foreign Application Priority Data
Oct. 1, 2009 (DE) 10 2009 044 156.5

(51) Int. Cl. G06Q 20/18; G06Q 20/20

(52) U.S. Cl. 705/20

(57) ABSTRACT

The invention relates to a system for detecting products at a self-service product detection station wherein an optical control detection device is provided for detected a number of products smaller than the total number of products presented for purchase, wherein products detected by the control detection device are each assigned identification data, and a verification device is presented by means of which the identification data of the products detected by means of the control detection device are checked for consistency with the identification data of the products detected with a reading device so that, depending on the comparison result, an acknowledgement signal continuing the purchasing procedure or a correction signal interrupting the purchasing procedure is generated.

### CROSS-REFERENCE TO RELATED APPLICATIONS

This application is a National Stage of International Application No. PCT/EP2010/005759, filed Sep. 21, 2010, and published in German as WO 2011/038849 A1 on Apr. 7, 2011. This application claims the benefit and priority of German Application 10 2009 044 156.5, filed Oct. 1, 2009. The entire disclosures of the above applications are incorporated herein by reference.

### BACKGROUND

This section provides background information related to the present disclosure which is not necessarily prior art.

### TECHNICAL FIELD

The invention relates to a system for detecting products at a self-service product detection station containing a reading device for detecting a number of products, wherein identification data are allocated to the products detected and wherein the reading device is operated by a customer him/herself, a registration device in which the identification data for the products provided by the reading device are allocated to price data so that, upon completion of the product detection, registration information about the products detected by the reading device can be output, and containing a payment device for transacting a payment based on the registration information.

The invention further relates to a method for detecting products at a self-service product detection station at which a specified number of products intended for sale are presented by customers in a placement area, then the products are detected by the customer activating a reading device, wherein product-specific identification data for the products detected are further processed to output registration information, so that the customer then pays the purchase price for the detected products contained in the registration information.

### DISCUSSION

A self-service product detection station is known from DE 20 2004 021 433 U1 at which customers independently undertake complete detection of the products, which is normally performed by a cashier, and subsequently pay for said products. The self-service product detection station therefore has a suitable reading device for detecting a specific number of products, wherein the reading device can be configured as an infrared scanner for example. After reading bar codes for the products, for example, these product-specific identification codes are made available to a registration device in which registration information, or price data allocated to the products detected, is generated so that said information or data are displayed in a display unit, for example a touch-sensitive screen, and the customer is requested to pay a total amount. The self-service product detection station has a payment device for this purpose so that the customer can then make the payment independently, wherein the payment device may have a card swipe reader for a cash-free payment. After paying for the detected goods, the customer receives a cash register receipt from a dispensing slot that usually shows the individual products with their prices and the total amount. In order to check that all the products presented by the customer at the product detection station are detected by the reading device, a weighing device is provided with a floor scale arranged on both sides of the reading device. Each time a product is scanned, a weight comparison is performed of the two floor scales holding a shopping cart. If the weight increase for the one floor scale corresponds to the weight decrease for the other floor scale, it is assumed that the scanning process has been carried out correctly by the customer so that the customer is prompted either visually or audibly to scan a further product. Particularly when used improperly, this weight check results in malfunctions that require the intervention of a supervisor.

### SUMMARY OF THE INVENTION

An object of the present invention is, therefore, to cite a system and a method for detecting products at a self-service product detection station so that verification of a purchase procedure with respect to completeness of the products detected by the customer can take place more simply and more quickly.

To achieve this object, an aspect of the invention is characterized in that an optical control detection device is provided to detect a number of products that is smaller than the total number of products presented for the purchase process, wherein identification data are allocated to the products detected by the control detection device, and a verification device, by means of which the identification data for the products detected by the control detection device are checked for consistency with the identification data for the products detected using the reading device so that depending on the comparison result, either a confirmation signal continuing the purchase process or a correction signal interrupting the purchasing process is generated.

The particular advantage of the invention is that through the use of an optical control detection device that detects a number of products presented for purchase at the product detection site, checking for any inconsistencies in the product detection process by the customer can be simplified, or the purchasing process can be speeded up, respectively. The use of the optical control detection device allows detection or scanning of the products without any intervention in the steps to be performed by the customer, such as scanning of or payment for the products. By eliminating a weighing step in the purchasing process, the purchasing process can usually be speeded up.

The identification data provided by the optical control detection device for the products detected are made available to a verification device in which a comparison is made of the identification data of the products detected by the customer. If an inconsistency is found, it is assumed that the customer has erroneously scanned the product in question or has not scanned the item itself with fraudulent intent. In this case, a corresponding correction signal is issued by a reporting device so that a supervisor can intervene in the purchasing process for the purpose of subsequently detecting the product not detected by the customer.

In accordance with a preferred embodiment of the invention, the effect of a verification device on the optical control detection device is such that only a part of the products presented is detected. As a result of this random-sample detection of the products presented, the volume of information in detection can be kept small so that almost one-hundred percent product identification is possible. Because the products presented for purchase are detected only in a random fashion by the control detection device, reliable verification can take place before the completion of the purchasing process by the customer without causing false alarms because of defective product detection.

In accordance with a preferred embodiment of the invention, the optical control detection device has an image detection instrument, specifically a digital camera, so that detection of the products is enabled with relatively high identification reliability (100%) using suitable object detection software. The image detection instrument is preferably programmed using the object detection software in such manner that all products are detected at least in part whenever possible. By presetting a random sample size of 30% of all products detected or presented, the image data for those products that have been unambiguously detected undergo further processing.

In accordance with a further development of the invention, the control detection device has a number and arrangement of image detection instruments such that a specified placement area in which the products to be detected by the customer are arranged is detected by the control detection device. As a result, it can be ensured that a large number of products can be detected with a high degree of identification reliability.

To achieve its object, an aspect of the method under the invention is characterized in that during product detection by at least one customer a number of products arranged in the placement area is additionally detected in a random sample manner, which is verified for consistency with the products detected by at least one customer and that, depending on the consistency verification, an acknowledgement signal or a correction signal is generated.

The particular advantage of the method in accordance with the invention is that verification for inconsistencies regarding detection of the products presented for purchase by the customer can take place quickly and reliably. Because the products presented for detection are detected only as a random sample, verification can be first of all be concluded within the time of the purchasing process determined by the customer. Secondly, relatively high identification reliability (almost 100%) in the identification of products can be achieved as a result, because only definitive identification data for the products detected are used for the random sampling detection. Because verification in accordance with the invention runs parallel to the detection and purchase process by the customer, the normal purchase process overall can be speeded up since the otherwise necessary interim step of check weighing is omitted. The random sample can be applied to the purchase process of each individual customer or a group of customers, so that in the latter case product detection is not verified by each customer.

In accordance with a further development of the invention, the verification for consistency of the products detected by the customer with the products detected by random sampling takes place after completion of the detection process by the customer. Said verification can take place immediately upon completion of the detection process by the customer, when all identification data for the products scanned by the customer are available. By comparing the appropriate identification data, a verification result can be obtained relatively quickly. In this connection, the product-specific identification data for the products obtained in a control detection device in a random sample can be forwarded automatically to a verification device where the comparison takes place. Alternatively, image data detected by the optical control detection device can also be visualized in a monitor so that individual products can be identified in random sampling by a checker, and then by selecting a suitable control program, it can be verified whether the product identified is consistent with a product detected by the customer. Verification is carried out using a registration list drawn up for the payment process so that in the event of faulty product detection by the customer a correction can be made in the purchase process, usually only after commencement of the payment process.

In accordance with a further development of the invention, only fewer than half of all products presented for the purchase process, preferably 30% of the products presented for purchase, are detected completely and taken for verification checking. In this way, a high degree of reliability in identifying the products is ensured.

### BRIEF DESCRIPTION OF THE DRAWINGS

Embodiments of the invention are explained in greater detail using the Figures.

The drawings described herein are for illustrative purposes only of selected embodiments and not all possible implementations, and are not intended to limit the scope of the present disclosure.

FIG. 1 shows a schematic side view of a self-service product detection station,

FIG. 2 shows a block diagram of a self-service product detection station in accordance with a first embodiment and

FIG. 3 shows a block diagram of a self-service product detection station in accordance with a second embodiment.

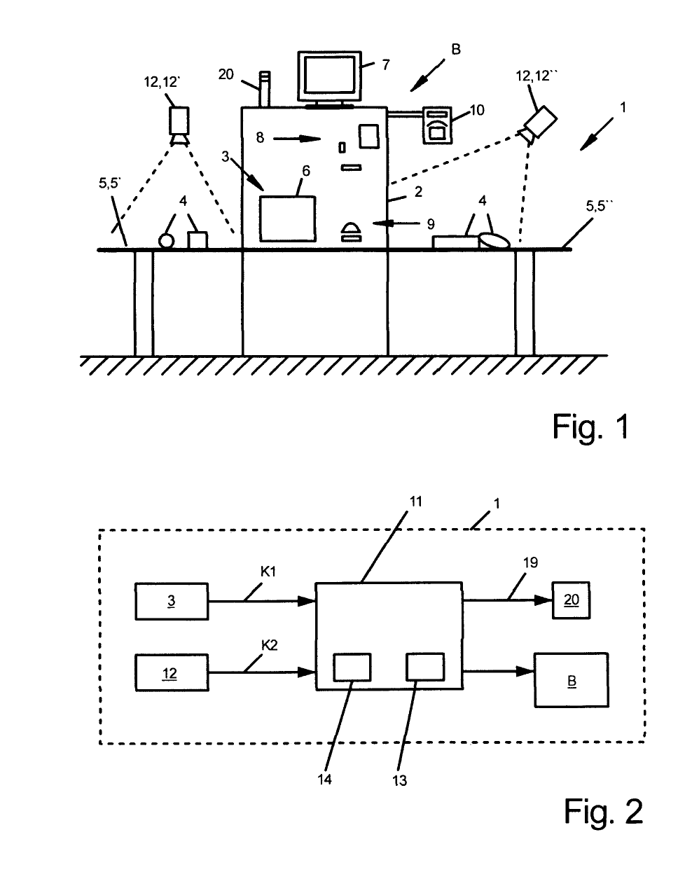

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

A self-service product detection station 1 is used for detecting products or articles by the customer him/herself without the need for assistance from a cash register clerk.

The self-service product detection station 1 has a terminal 2 into which a reading device 3 for detecting products 4 is integrated. The reading device 3 is preferably configured as a conventional barcode reading instrument.

The products 4 presented for a purchase process are held against a scanning disc 6 of the reading device 3, either directly from a customer's shopping basket or shopping cart or from a placement table 5 arranged adjacent to terminal 2. Correct detection of the corresponding product 4 is signaled by a corresponding beep. After the customer has scanned all the products 4 presented or intended for purchase, he can conclude the scanning process by pressing an area on a touch-sensitive screen 7 provided for this purpose. Then the payment process is initiated by the request to pay the appropriate purchase amount with cash or with a card in a payment device B. For a payment in cash, terminal 2 has a slot 8 for coins and/or bank notes and a dispenser 9 for change. A card reader 10 extends from terminal 2 to make a cash-free payment.

A registration device 11 is arranged in the terminal 2 containing a data processing instrument so that the product-specific identification data K₁ detected by the reading device 3 can be processed and allocated in each case to the corresponding price data allocated to the products. Corresponding registration information is generated in the registration device 11 that consists essentially of a list of the products detected 4, the matching prices and the total amount. This registration information can be displayed on the touch-sensitive screen 7 and in the form of a register receipt (sales slip) by means of a printer integrated into terminal 2 following payment. Alternatively, the register receipt can also be printed immediately after scanning is completed, when the customer has to scan said register receipt again before he pays the purchase price.

The registration information for the individual products 4 can also be displayed on the screen 7 step by step with each scanning action so that the customer has visual verification that the product in question has been successfully scanned.

In order to verify whether the customer has scanned all the products 4 presented for purchase, a control detection device 12 is provided that, in the present invention, has two optical image detection devices arranged above the placement table 5 (placement area). These image detection devices 12 are configured in each instance as a digital camera with a CCD sensor, where the one camera 12′ is arranged oriented to the placement table 5 at a height such that the products 4 deposited on the placement table 5′ arranged on one side of terminal 2 can be detected. The other camera 12″ is arranged and aligned on a side opposite terminal 2 in such a way that the additional matching placement table 5″ arranged below is detected in its entirety so that corresponding image data of products 4 deposited on the placement table 5 can be generated. The image data generated by the cameras 12′, 12″ are transmitted as identification date K₂ to the registration device 11 in accordance with a first embodiment of the invention from FIG. 2. The registration device 11 has a verification device 13, in which the image data K₂ prepared by the control detection device 12 are processed. Specifically, the registration device 11 can have a checking and control program 14 by means of which image data K₂ of only one part of the identification data K₂ corresponding to the total products 4 presented are taken for further verification. This selection of image data K₂ can be made on a random basis, where less than half of the products 4 detected by the control detection device 12 and presented by the customer for the purchase process are taken for later verification. Using this process, identification reliability specifically of the correspondingly detected products 4 can be improved so that erroneous detection can be excluded. It is, for example, sufficient to take a random sample of a maximum of 30% of the products 4 presented for verification.

This spot check does not have to refer to products of a single customer. Provision can also be made for the spot check to refer to products of a group of customers so that it may happen that in individual cases the products 4 presented by a customer are not checked at all for consistency with the products actually detected by the customer.

The verification device 13 has in addition a comparison program 15 by means of which the consistency of the products 4 additionally detected by the control detection device 12 is compared with the products 4 detected by the customer. To this end, the correspondingly prepared identification data K₁ for the products that the customer has detected using the reading device 3 are compared with the identification data K₂ that the control detection device 12 has detected.

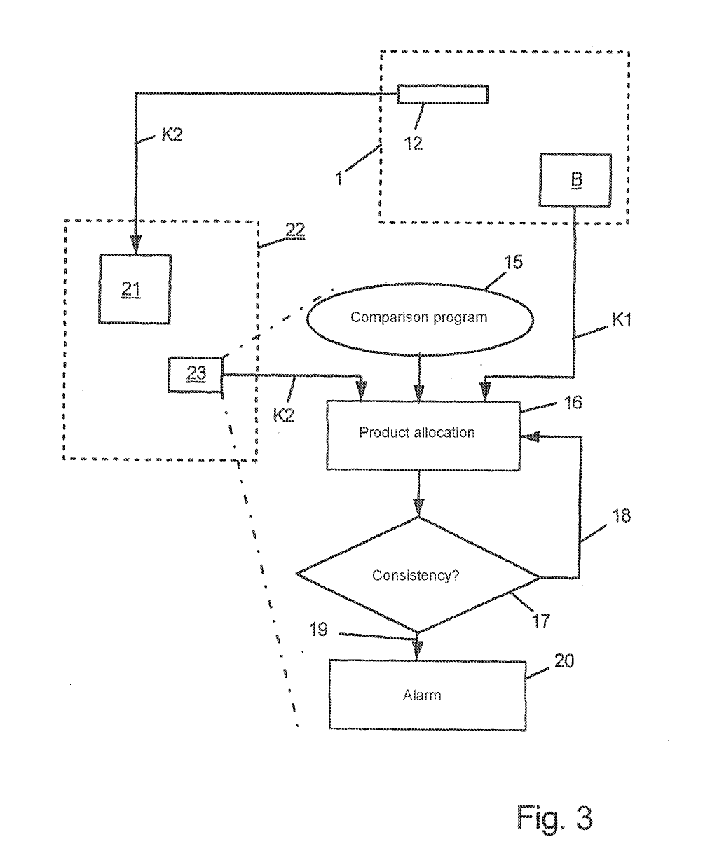

As can be seen specifically from FIG. 3, the identification data K₂ for the checked products 4 are compared step by step with the identification data K₁ generated as a result of scanning by the customer in a further step 17 by means of the comparison program 15, following sequential allocation of the identification data K₂ to the identification data K₁ in accordance with step 16. If consistency can be established, an acknowledgement signal 18 is generated so that the identification data K₂ for the next products 4 can be checked. If consistency is negative, a correction signal 19 is generated that is transmitted to a reporting device 20 to output an alarm signal. For example, the reporting device 20 can be designed as a beacon emitting a red light that extends in a column shape 19 from terminal 2. If such a a correction signal 19 is generated, it can be assumed with great certainty that the customer has not scanned the product 4 detected through a spot check by the control detection device 12 so that the purchasing process is interrupted and the appropriate scanning for the product 4 in question can be repeated with the assistance of an attendant.

In accordance with an alternative embodiment of the invention from FIG. 3, in contrast to the aforementioned embodiment, the image data K₂ detected by the control detection device 12 are transmitted to a stationary monitor 21 at a control station 22 and shown in visual form there. The image data K₂ can comprise a marking, a bar code for the products 4 for example, and/or a shape and/or a size and/or a graphic representation of the products 4. It is essential that the checker provides only image data K₂ of such items 4 for inspection that are definitively identified.

A checker sitting at the checking station 22 can now identify products one after the other, following a predetermined scheme or in any order, and select these identified products in a verification device 23. For this purpose, the verification device 23 can have a plurality of pictogram keys, for example, that are allocated in each instance to a specific product category or the products themselves. Alternatively, the checker can also enter a code corresponding to the detected products into an entry unit in the verification device 23.

As already described regarding the first embodiment, the random sample verification of the products detected by the control detection device 12 is performed in the verification device 23 using the products detected by the reading device 3.

In accordance with an alternative embodiment of the invention, the presentation of the identification data K₂ prepared by the control detection device 12 in accordance with the first embodiment and the second embodiment provided to the comparison program 15 can also be undertaken overlapping one another. As a result, redundancy, or greater control reliability is generated.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A system for detecting products at a self-service product detection station comprising:
a reading device for detecting a number of products, wherein the detected products are allocated identification data and wherein the reading device is operated by a customer him/herself,
a registration device in which the identification data prepared by the reading device for the products are allocated to price data so that, upon completion of the product detection, registration information about the products detected by means of the reading device is output,
a payment device for transacting a payment process based on the registration information, wherein
an optical control detection device for detecting a number of products that is smaller than the total number of the products presented for the payment process, wherein the products detected by the control detection device are allocated identification data, and
a verification device by means of which the identification data of the products detected by the control detection device are checked for consistency with the identification data of the products detected by the reading device so that, depending on the comparison signal result, an acknowledgement signal continuing the purchase process or a correction signal interrupting the purchase process is generated.

2. The system according to claim 1, wherein the verification device has a checking and control program by means of which, depending on a degree of identification of the products by the control detection device, identification data for a part of the products presented are taken to verify consistency with identification data for the products.

3. The system according to claim 1, wherein the optical control detection device is configured as an image detection instrument, wherein lettering and/or a shape and/or a size and/or a graphic representation of the product can be detected.

4. The system according to claim 1, wherein the reading device is configured as a barcode reader.

5. The system according to claim 1, wherein the control detection device has a number and/or an arrangement of digital cameras such that a predetermined placement area can be detected on which the products presented for the purchase process are deposited.

6. The system according to claim 1, wherein the verification device has a data processing unit with a comparison program by means of which the consistency of the products detected by the control detection device with the products detected by the reading device can be verified.

7. The system according to claim 1, wherein a reporting device is arranged to output the acknowledgement signal and/or the correction signal at the product detection station.

8. A method for detecting products at a self-service station at which a predetermined number of products presented for purchase are prepared in a placement area by customers, then the products are detected by the customer activating a reading device, comprising wherein product-specific identification data for the detected goods are further processed to output registration information so that subsequently the customer pays the purchase price for the detected products contained in the registration information, wherein while the products are being detected by at least one customer a number of products arranged in the placement area is detected in addition on a random sample basis that is checked for conformity with the products detected by the at least one customer, and that, depending on the consistency check, an acknowledgement signal or a correction signal is generated.

9. The method according to claim 8, wherein the consistency check is made after the detection process for the products by the customer has been completely concluded.

10. The method according to claim 8, wherein the identification data for the products detected in a spot check are displayed as image data on a remote monitor so that individual products are identified by a checker and, by selecting a comparison program, verification takes place whether the identified products are consistent with a product detected by the customer.

11. The method according to claim 8, wherein fewer than half of all products presented for a purchase process at the placement area are checked for consistency with the products detected by the customer.
